(19) United States
(12) Patent Application Publication
(10) Pub. No.: US 2015/0031005 A1
(43) Pub. Date: Jan. 29, 2015

(54) Method of Training Verbal and/or Visual Information Processing By Executing Computer-Executable Instructions Stored On a Non-Transitory Computer-Readable Medium

(71) Applicant: Ross Alloway, Jacksonville, FL (US)

(72) Inventor: Ross Alloway, Jacksonville, FL (US)

(21) Appl. No.: 14/340,544

(22) Filed: Jul. 24, 2014

Related U.S. Application Data
(60) Provisional application No. 61/858,029, filed on Jul. 24, 2013.

(51) Int. Cl. G09B 5/02

(52) U.S. Cl. CPC G09B 5/02
USPC 434/236

(57) ABSTRACT

A method of training verbal and/or visual information allows a user to train their cognitive processing of verbal or visual information. A plurality of visual stimuli is sequentially displayed on a display device, and the user is tasked with identifying whether a stimuli currently displayed was displayed a specified number of elements in the sequence prior to the current element. Each of the visual stimuli is associated with one of a plurality of categories, and the category or categories to be trained may vary. A stimuli recall event may be triggered which challenges the user to recall their previous correct answers.

The current application claims a priority to the U.S. Provisional Patent application Ser. No. 61/858,029 filed on Jul. 24, 2013.

### FIELD OF THE INVENTION

The present invention relates generally to cognitive information processing. More particularly, the present invention relates to a method for training users in cognitively processing verbal and visual information.

### BACKGROUND OF THE INVENTION

Training the cognitive processing of verbal and visual information may help people identify verbal and visual information (words and images) relevant to a verbally and/or visually demanding task. Such training may also help them learn to process the meanings to which the words or visual information refer. The present invention encourages improvement of the cognitive processing of verbal and/or visual information, and may be applied to a variety of contexts, for example, in the processing of emotional-verbal and visual information, or in the processing of professional-verbal and visual information, such as legal terminology or images relevant to the correct operation of machinery (for example, hazard symbols and other symbols in the dashboard of a car).

### BRIEF DESCRIPTION OF THE DRAWINGS

FIG. 1 is an example of a list of stimuli to be presented to the user.

FIG. 2 is an example of a list of stimuli to be presented to the user.

FIG. 3 is an example of a list of stimuli to be presented to the user.

FIG. 4 is an example of a list of stimuli to be presented to the user.

FIG. 5 is a stepwise flow diagram of the general process of the present invention.

FIG. 6 is a stepwise flow diagram of the process for recording a correct or incorrect stimulus answer.

FIG. 7 is a stepwise flow diagram of the process for recording a correct or incorrect category answer.

FIG. 8 is a stepwise flow diagram of the process for another situation for recording a correct or incorrect stimulus answer.

FIG. 9 is a stepwise flow diagram describing triggers for a stimulus recall event.

FIG. 10 is a stepwise flow diagram describing a stimulus recall event.

FIG. 11 is a stepwise flow diagram of the process for determining the timing for displaying stimuli.

FIG. 12 is a stepwise flow diagram further describing the visual stimuli and how the sequential order is determined.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a method for training users in verbal and/or visual information processing. The preferred embodiment of the present invention is delivered on a computing device, such as, but not limited to, a desktop computer, a laptop computer, or a mobile device such as a tablet computer, cell phone, or any other device with a means for displaying, receiving, and processing information. The computing device should have a display device or means and an input device or means. For example, with a desktop computer the display device is a monitor and the input device is a keyboard, mouse or other input device. With a touch screen tablet computer, the touch screen functions as both the display device and the input device. In alternate embodiments of the present invention, alternate mediums may be used, such as, but not limited to, a printed medium such as a book, or an auditory medium.

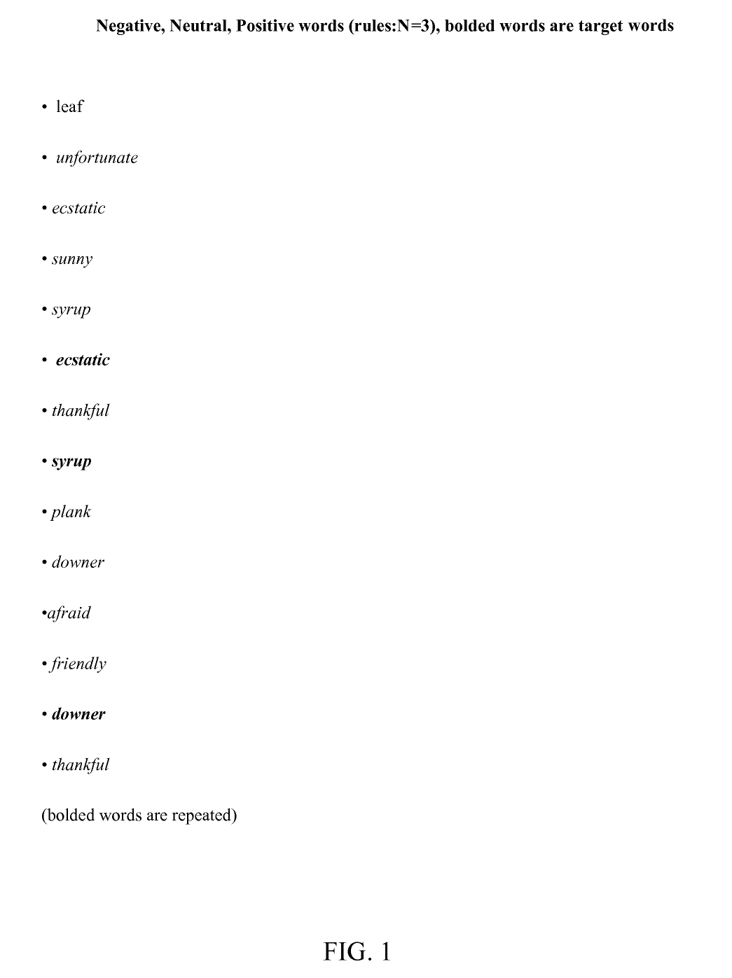

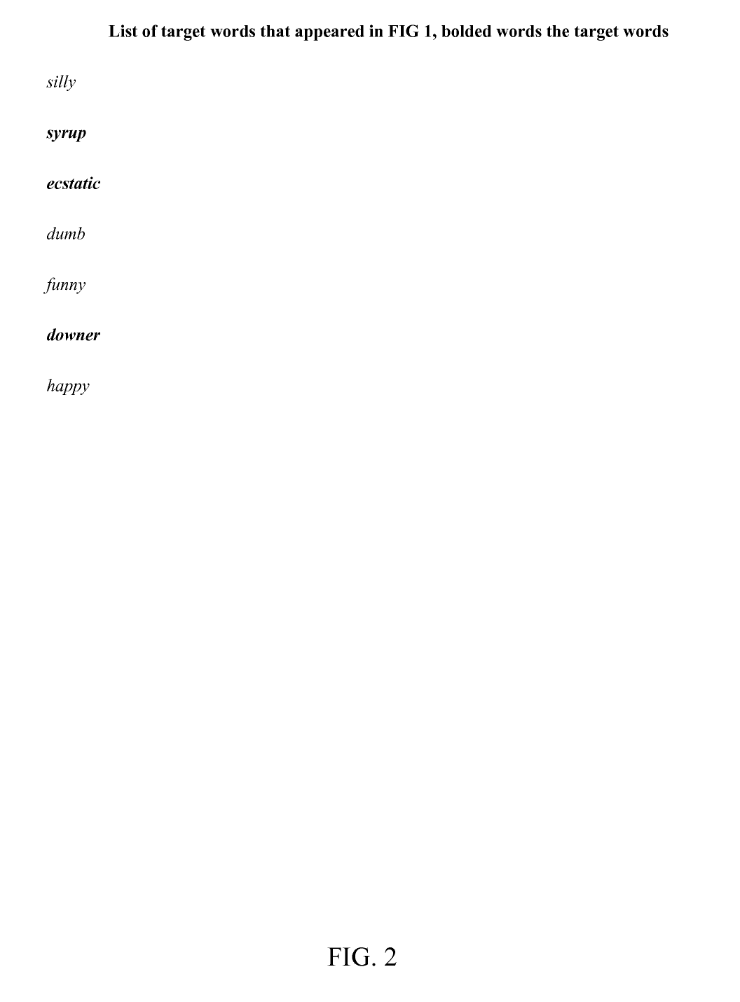

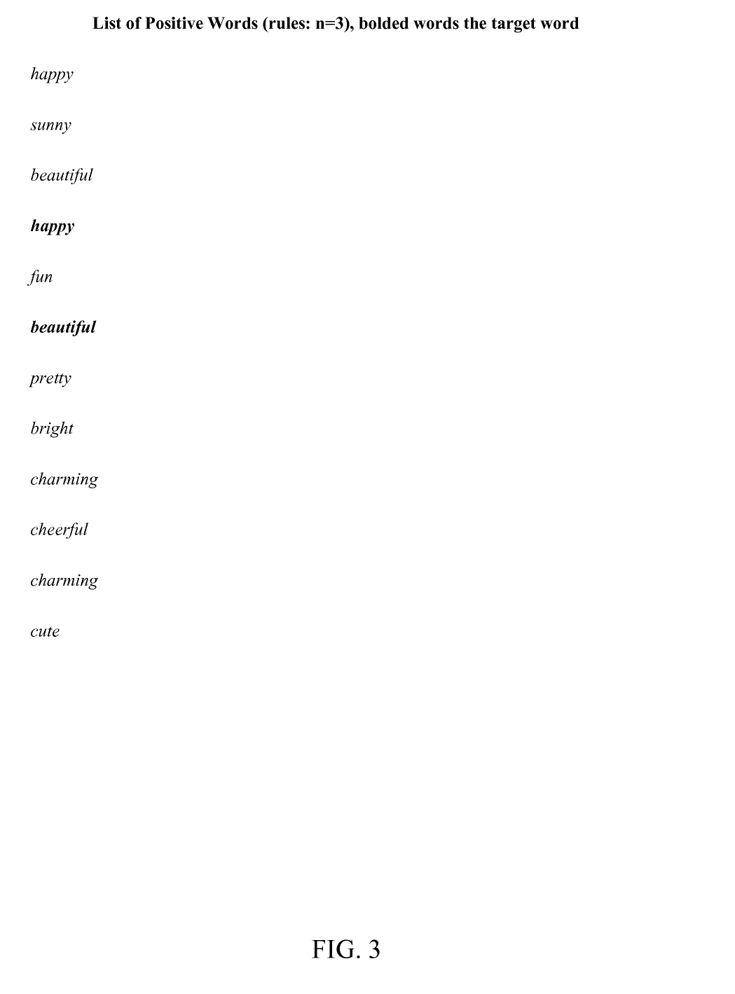

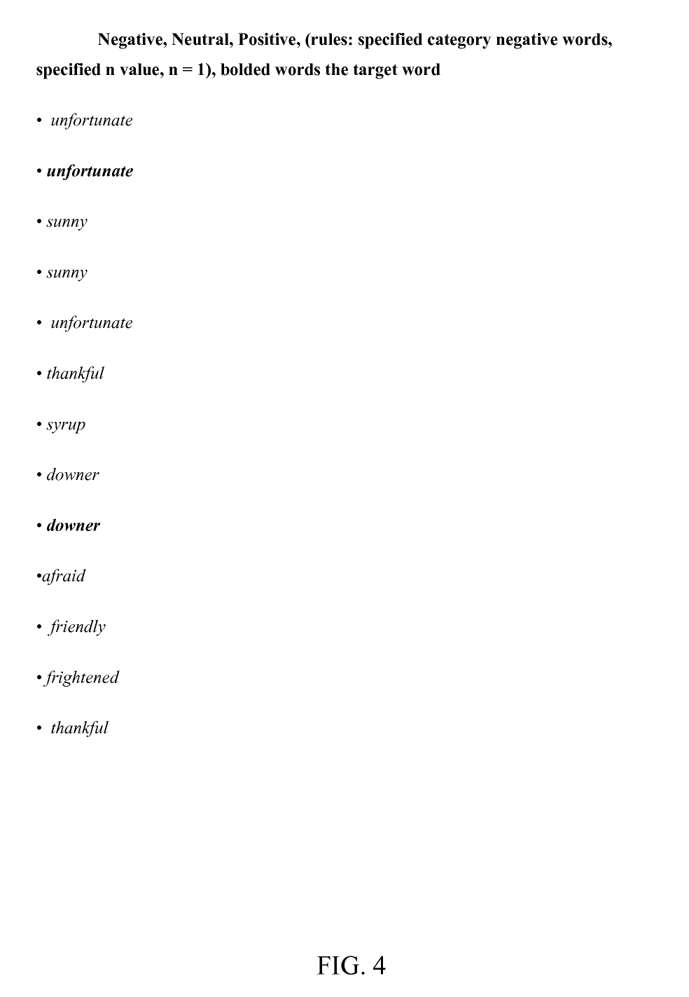

In the preferred embodiment of the present invention, a plurality of words is presented one at a time to a user. The user observes the words, and makes a judgment as to whether the word currently being observed appeared a specified number of words previously. The present invention is preferably delivered on a computing device as a game or other application. A session of the present invention refers to a period of time during which a user trains their verbal information processing by interacting with the present invention, observing the words and making judgments as to whether the current word appeared a specified number of words previously. Examples of word lists can be seen in FIGS. 1-4.

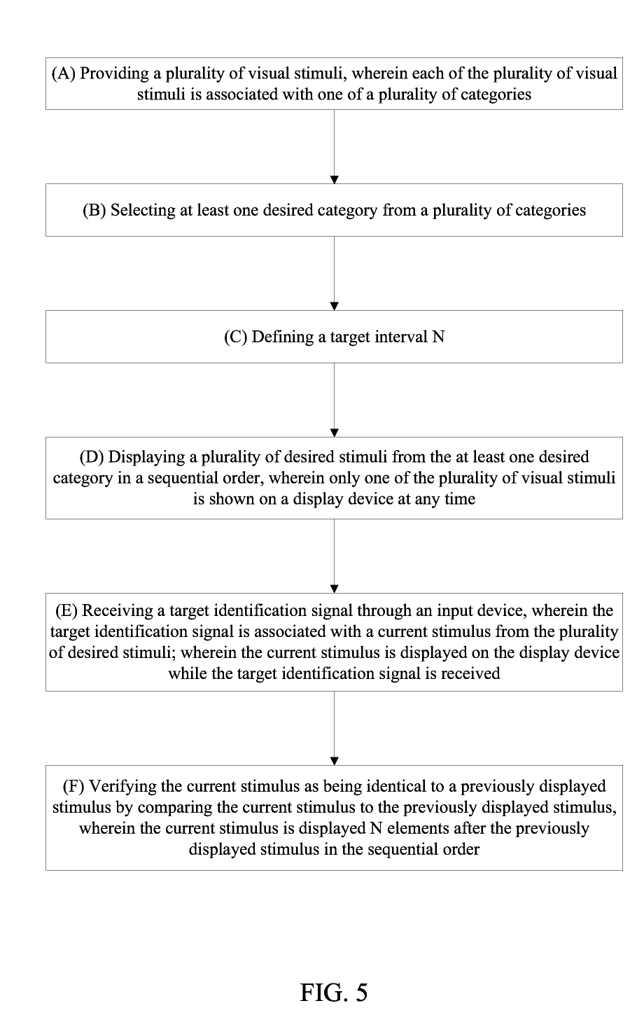

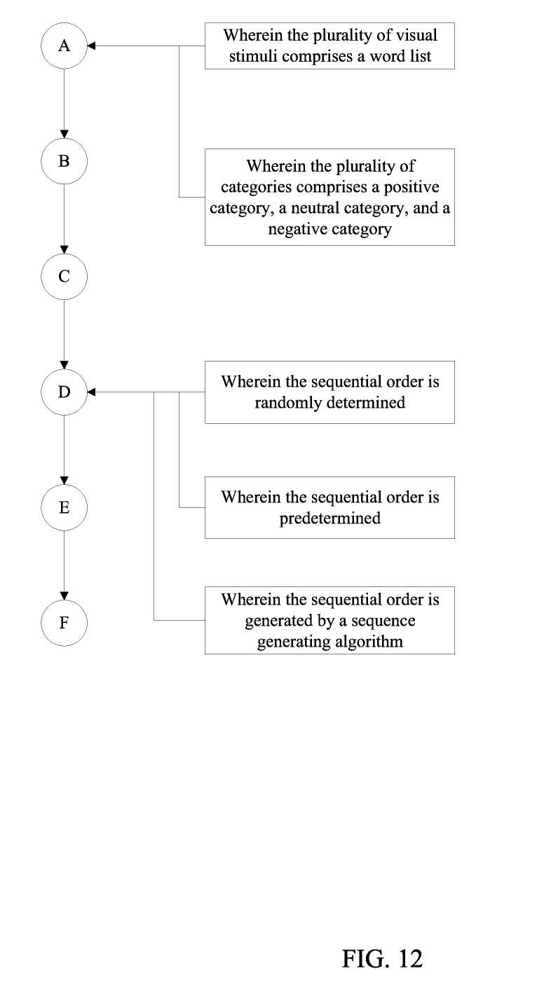

Referring to FIG. 5, more specifically, a plurality of visual stimuli is provided (step A), wherein each of the plurality of visual stimuli is associated with one of a plurality of categories. In the preferred embodiment of the present invention, the plurality of visual stimuli comprises a word list, each of the plurality of visual stimuli is a word, and the plurality of categories comprises a positive category, a neutral category, and a negative category, as shown in FIG. 12. The positive category comprises words that are emotionally positive, such as “ecstatic” “sunny” or “thankful.” The neutral category comprises words that are emotionally neutral, such as “leaf” “syrup” or “plank.” The negative category comprises words that are emotionally negative, such as “unfortunate” “downer” or “afraid.” Other categories not mentioned herein may also be used. Although in the preferred embodiment of the present invention, each of the stimuli plurality of visual stimuli is a word, it is contemplated that in alternate embodiments alternate or additional stimuli may be comprised, such as, but not limited to, images, letters, numbers, symbols, or combinations of various types of visual stimuli.

At least one desired category is selected from the plurality of categories to be used in a session (step B). In one embodiment of the present invention, the categories to be used are predetermined and not able to be changed by the user. In another embodiment, the user may be presented with the option to manually select the at least one desired category. Any combination of categories may be used, such as only one category, the positive category and the neutral category, the neutral category and the negative category, the positive category and the negative category, or all three categories.

A target interval N is defined (step C). The target interval determines the gap for correctly identifying identical words, wherein the user attempts to identify a word that was displayed N words before the currently displayed word. The target interval may be any integer, but is preferably between 1 and 10.

A plurality of desired stimuli from the at least one desired category is displayed as elements in a sequential order, wherein only one of the plurality of visual stimuli is shown on the display device at any time (step D). The sequential order may be determined in multiple ways, as shown in FIG. 12. In one embodiment, the sequential order is randomly determined. In another embodiment, the sequential order is predetermined. In another embodiment, the sequential order is generated by a sequence generating algorithm which uses any relevant means to generate a sequential order.

A target identification signal is received by the processing unit of the computing device through the input device, wherein the target identification signal is associated with a current stimulus from the plurality of desired stimuli, and wherein the current stimulus is displayed on the display device while the target identification signal is received (step E). While the stimuli are being sequentially displayed, the user is provided with the option to input the target identification signal at any time, by performing an action such as clicking a button to indicate their choice.

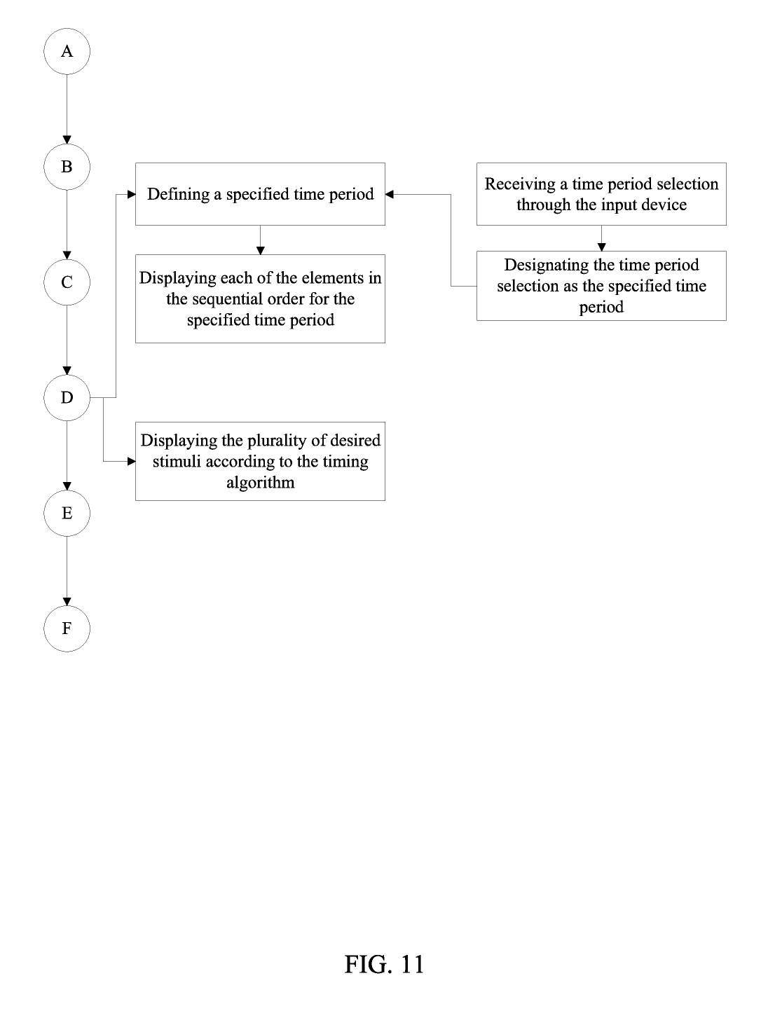

Referring to FIG. 11, timing of the displaying of the stimuli may be defined in multiple ways. In one embodiment, a specified time period is defined, and each of the elements in the sequential order is displayed for the specified time period. Depending on the specific implementation of the present invention, the specified time period may be predetermined, or a time period selection may be received through the input device from the user, and the time period selection is then designated as the specified time period. Alternatively, a timing algorithm may be provided, and the plurality of desired stimuli is displayed according to the timing algorithm. The timing algorithm may generate timing schemes as needed, or the timing algorithm may display specific stimuli or categories for varying time periods, or the timing algorithm may perform other relevant functions not herein described.

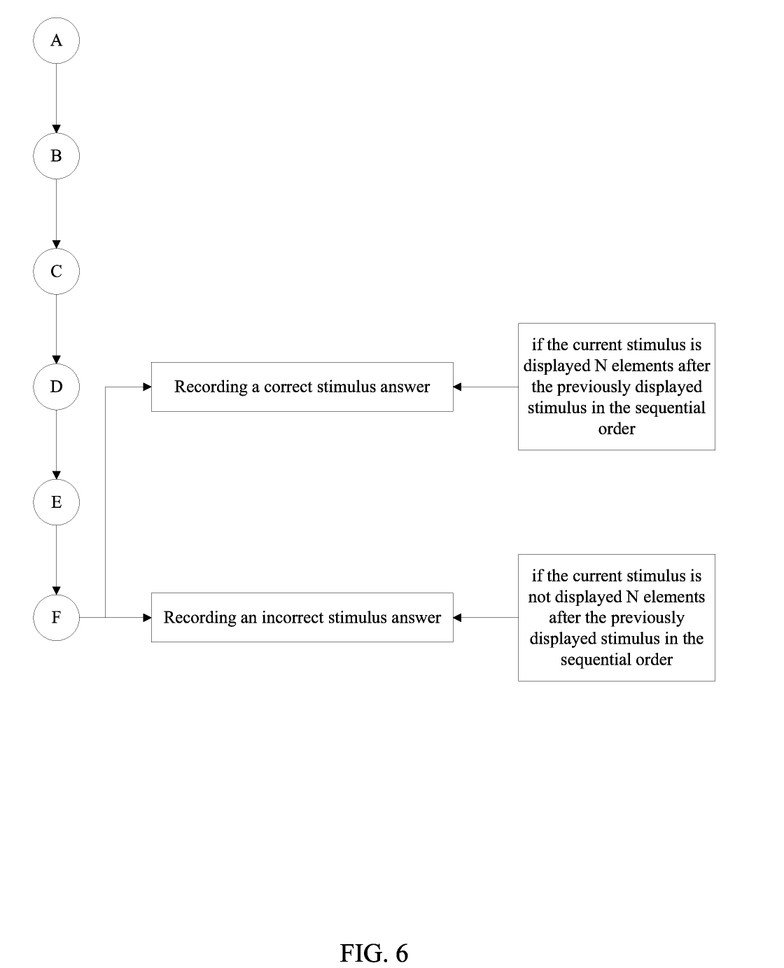

Once the target identification signal is received, the current stimulus is verified as being identical to a previously displayed stimulus by comparing the current stimulus to the previously displayed stimulus, wherein the current stimulus is displayed N elements after the previously displayed stimulus in the sequential order (step F). In one preferred embodiment of the present invention, the user must only identify a stimulus that was displayed N elements previously. As shown in FIG. 6, a correct stimulus answer is recorded if the current stimulus was displayed N elements after the previously displayed stimulus in the sequential order, and an incorrect stimulus answer is recorded if the current stimulus is not displayed N elements after the previously displayed stimulus in the sequential order.

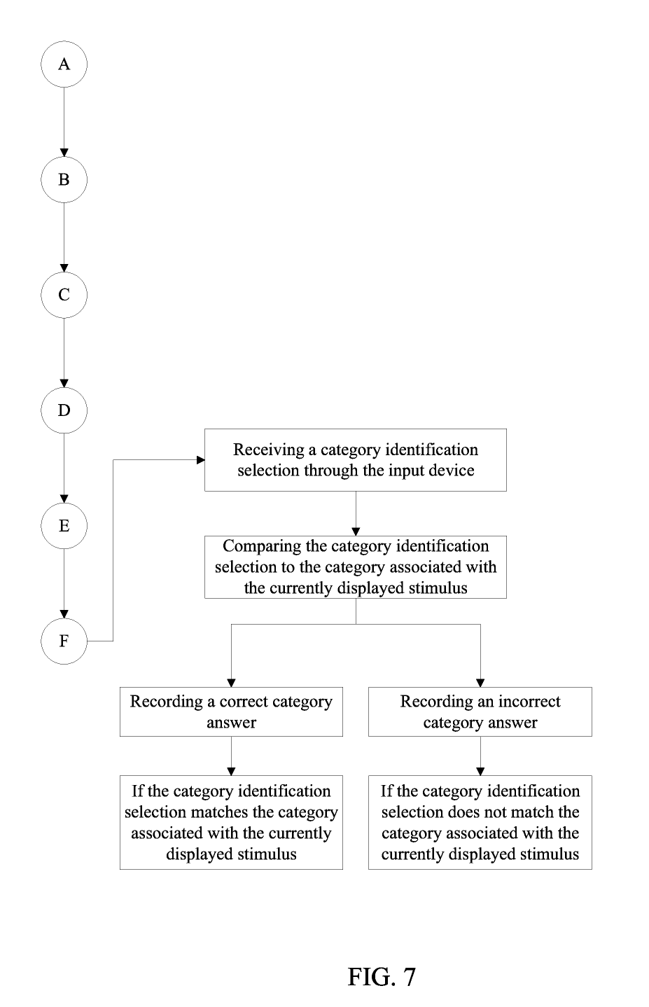

As shown in FIG. 7, after making a correct stimulus answer, the user may then be prompted to identify which category the current stimulus is associated with. A category identification selection interface is presented to the user, with which the user makes a category identification selection through the input device, which is received by the processing unit of the computing device. The category identification selection is compared to the category associated with the current stimulus. A correct category answer is recorded if the category identification selection matches the category associated with the current stimulus, and an incorrect category answer is recorded if the category identification selection does not match the category associated with the current stimulus.

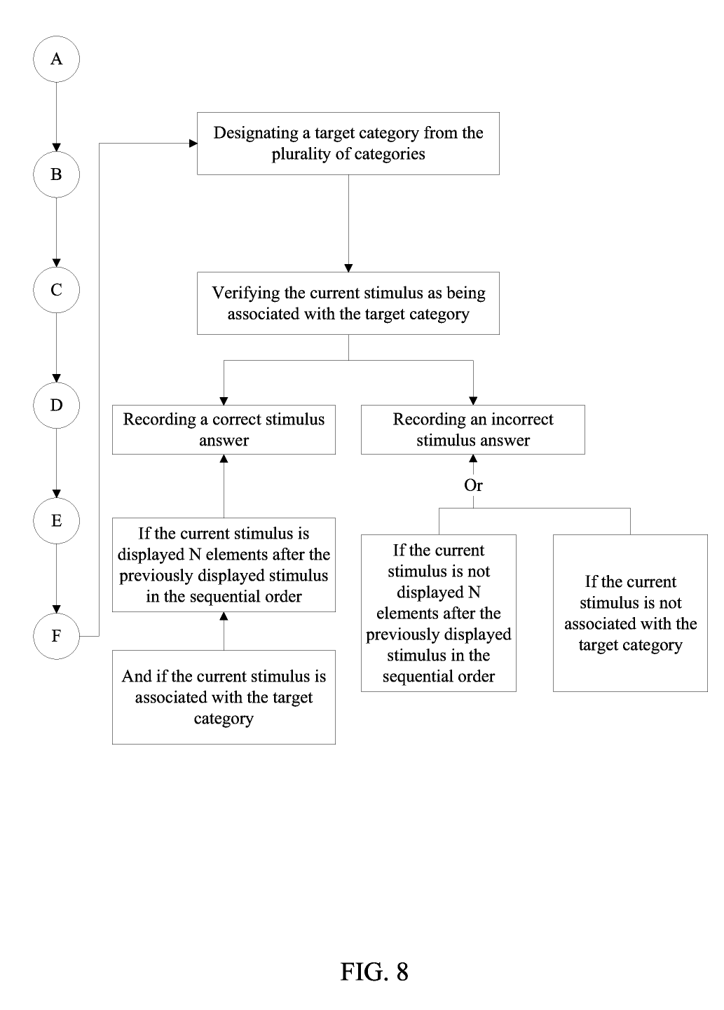

In one embodiment of the present invention, the user is required to identify target stimuli that belong to a specific category, as shown in FIG. 8. A target category from the plurality of categories is designated. Once the target identification signal is received, the current stimulus is verified as being associated with the target category. In this case, a correct stimulus answer is recorded if the current stimulus is displayed N elements after the previously displayed stimulus in the sequential order, and if the current stimulus is associated with the target category. An incorrect stimulus answer is recorded if the current stimulus is not displayed N elements after the previously displayed stimulus in the sequential order, or if the current stimulus is not associated with the target category.

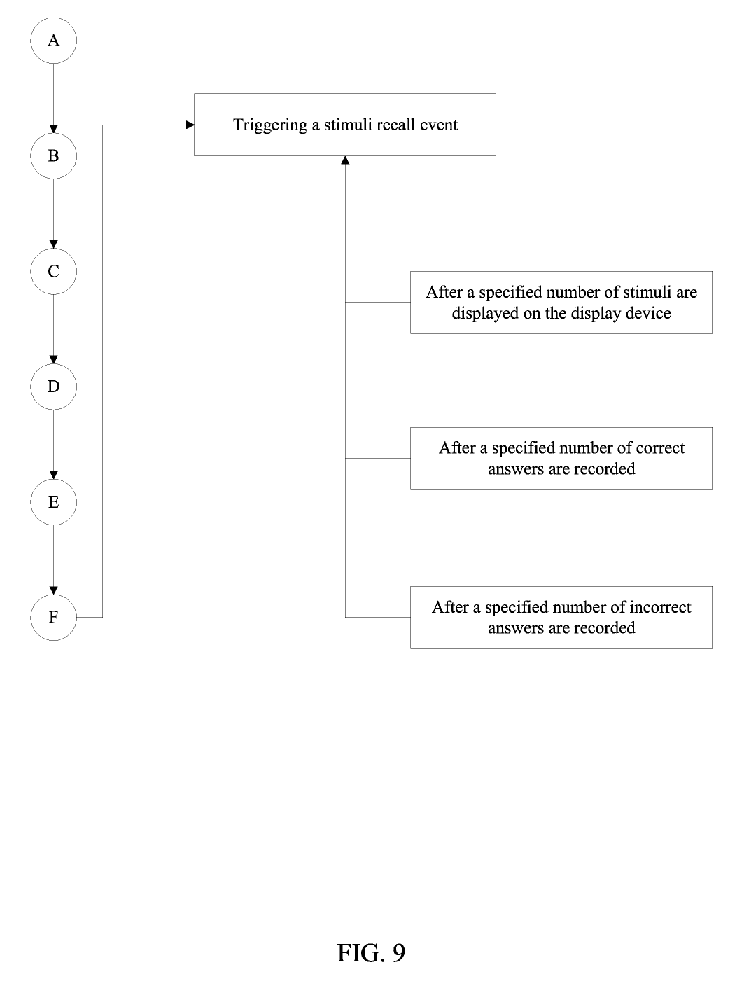

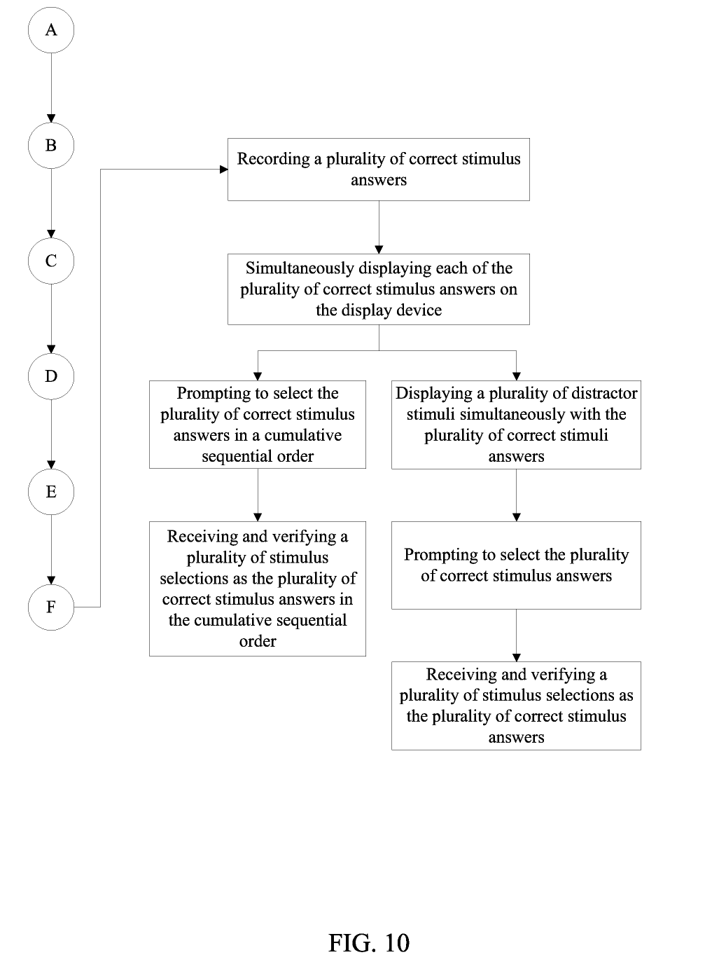

Referring to FIGS. 9-10, an additional feature comprised in the preferred embodiment of the present invention is a stimuli recall event. The stimuli recall event happens at pre-defined points during a session. In one embodiment, the stimuli recall event is triggered after a specified number of stimuli are displayed on the display device. Alternatively, the stimuli recall event may be triggered after a specified number of incorrect answers are recorded, or after a specified number of correct answers are recorded. A plurality of correct stimulus answers is recorded through the course of a session, and the stimuli recall event challenges the user to recall the correct stimulus answers. Each of the plurality of correct stimulus answers is simultaneously displayed on the display device, preferably in a list format, though alternate arrangements may be used.

In one embodiment, the stimuli recall event challenges the user to recall the correct stimulus answers in the order they occurred. The user is prompted to select the plurality of correct stimulus answers in a cumulative sequential order, wherein the cumulative sequential order is the order in which the plurality of correct stimulus answers were previously recorded. A plurality of stimulus selections is input by the user, received by the computing device and verified as to whether or not the plurality of stimulus selections matches the plurality of correct stimulus answers in the cumulative sequential order.

In another embodiment, the stimuli recall event challenges the user to remember and pick out the correct stimulus answers from amongst a plurality of distractor stimuli. The plurality of distractor stimuli is displayed simultaneously with the plurality of correct stimuli. The categories associated with the distractor stimuli may be contextually different from the category associated with the correct stimuli, though this is not necessarily true in all embodiments. The user is prompted to select the plurality of correct stimulus answers, and a plurality of stimulus selections is received and verified as to whether or not the stimulus selections match the correct stimulus answers.

In another embodiment, the stimuli recall event may challenge the user to recall the plurality of correct stimuli in reverse order, in alternating order, or a different order as desired.

Although the invention has been explained in relation to its preferred embodiment, it is to be understood that many other possible modifications and variations can be made without departing from the spirit and scope of the invention as hereinafter claimed.

What is claimed is:

1. A method of training verbal and/or visual information processing by executing computer-executable instructions stored on a non-transitory computer-readable medium comprises the steps of:
(A) providing a plurality of visual stimuli, wherein each of the plurality of visual stimuli is associated with one of a plurality of categories;
wherein the plurality of categories comprises categories of words and images;
(B) selecting at least one desired category from the plurality of categories;
(C) defining a target interval N;
(D) displaying a plurality of desired stimuli from the at least one desired category as elements in a sequential order, wherein only one of the plurality of visual stimuli is shown on a display device at any time;
(E) receiving a target identification signal through an input device,
wherein the target identification signal is associated with a current stimulus from the plurality of desired stimuli;
wherein the current stimulus is displayed on the display device while the target identification signal is received; and
(F) verifying the current stimulus as being identical to a previously displayed stimulus by comparing the current stimulus to the previously displayed stimulus, wherein the current stimulus is displayed N elements after the previously displayed stimulus in the sequential order.

2. The method of training verbal and/or visual information processing by executing computer-executable instructions stored on a non-transitory computer-readable medium as claimed in claim 1 comprises the steps of:
recording a correct stimulus answer, if the current stimulus is displayed N elements after the previously displayed stimulus in the sequential order; and
recording an incorrect stimulus answer, if the current stimulus is not displayed N elements after the previously displayed stimulus in the sequential order.

3. The method of training verbal and/or visual information processing by executing computer-executable instructions stored on a non-transitory computer-readable medium as claimed in claim 1 comprises the steps of:
receiving a category identification selection through the input device;
comparing the category identification selection to the category associated with the current stimulus;
recording a correct category answer, if the category identification selection matches the category associated with the current stimulus; and
recording an incorrect category answer, if the category identification selection does not match the category associated with the current stimulus.

4. The method of training verbal and/or visual information processing by executing computer-executable instructions stored on a non-transitory computer-readable medium as claimed in claim 1 comprises the steps of:
designating a target category from the plurality of categories;
verifying the current stimulus as being associated with the target category;
recording a correct stimulus answer,
if the current stimulus is displayed N elements after the previously displayed stimulus in the sequential order,
and if the current stimulus is associated with the target category; and
recording an incorrect stimulus answer,
if the current stimulus is not displayed N elements after the previously displayed stimulus in the sequential order,
or if the current stimulus is not associated with the target category.

5. The method of training verbal and/or visual information processing by executing computer-executable instructions stored on a non-transitory computer-readable medium as claimed in claim 1 comprises the step of:
triggering a stimuli recall event.

6. The method of training verbal and/or visual information processing by executing computer-executable instructions stored on a non-transitory computer-readable medium as claimed in claim 5 comprises the steps of:
triggering the stimuli recall event, after a specified number of stimuli are displayed on the display device.

7. The method of training verbal and/or visual information processing by executing computer-executable instructions stored on a non-transitory computer-readable medium as claimed in claim 5 comprises the steps of:
triggering the stimuli recall event, after a specified number of incorrect stimulus answers are recorded.

8. The method of training verbal and/or visual information processing by executing computer-executable instructions stored on a non-transitory computer-readable medium as claimed in claim 5 comprises the steps of:
triggering the stimuli recall event, after a specified number of correct stimulus answers are recorded.

9. The method of training verbal and/or visual information processing by executing computer-executable instructions stored on a non-transitory computer-readable medium as claimed in claim 1 comprises the steps of:
recording a plurality of correct stimulus answers; and
simultaneously displaying each of the plurality of correct stimulus answers on the display device.

10. The method of training verbal and/or visual information processing by executing computer-executable instructions stored on a non-transitory computer-readable medium as claimed in claim 9 comprises the steps of:
prompting to select the plurality of correct stimulus answers in a cumulative sequential order, wherein the cumulative sequential order is the order in which the plurality of correct stimulus answers are recorded; and
receiving and verifying a plurality of stimulus selections as the plurality of correct stimulus answers in the cumulative sequential order.

11. The method of training verbal and/or visual information processing by executing computer-executable instructions stored on a non-transitory computer-readable medium as claimed in claim 9 comprises the steps of:
displaying a plurality of distractor stimuli simultaneously with the plurality of correct stimuli answers, wherein the categories associated with the plurality of distractor stimuli are contextually different from the category associated with the plurality of correct stimuli;
prompting to select the plurality of correct stimulus answers; and
receiving and verifying a plurality of stimulus selections as the plurality of correct stimulus answers.

12. The method of training verbal and/or visual information processing by executing computer-executable instructions stored on a non-transitory computer-readable medium as claimed in claim 1 comprises the steps of:
defining a specified time period; and
displaying each of the elements in the sequential order for the specified time period.

13. The method of training verbal and/or visual information processing by executing computer-executable instructions stored on a non-transitory computer-readable medium as claimed in claim 11 comprises the steps of:
receiving a time period selection through the input device; and
designating time period selection as the specified time period.

14. The method of training verbal and/or visual information processing by executing computer-executable instructions stored on a non-transitory computer-readable medium as claimed in claim 1 comprises the steps of:
providing a timing algorithm; and
displaying the plurality of desired stimuli according to the timing algorithm.

15. The method of training verbal and/or visual information processing by executing computer-executable instructions stored on a non-transitory computer-readable medium as claimed in claim 1, wherein the plurality of visual stimuli comprises a word list.

16. The method of training verbal and/or visual information processing by executing computer-executable instructions stored on a non-transitory computer-readable medium as claimed in claim 1, wherein the plurality of categories comprises a positive category, a neutral category, and a negative category.

17. The method of training verbal and/or visual information processing by executing computer-executable instructions stored on a non-transitory computer-readable medium as claimed in claim 1, wherein the sequential order is randomly determined.

18. The method of training verbal and/or visual information processing by executing computer-executable instructions stored on a non-transitory computer-readable medium as claimed in claim 1, wherein the sequential order is predetermined.

19. The method of training verbal and/or visual information processing by executing computer-executable instructions stored on a non-transitory computer-readable medium as claimed in claim 1, wherein the sequential order is generated by a sequence generating algorithm.
